(19) United States
(12) Patent Application Publication
(10) Pub. No.: US 2021/0053854 A1
(43) Pub. Date: Feb. 25, 2021

(54) Process for treating a sulfide-containing waste lye

(71) Applicant: LINDE GmbH, Pullach (DE)

(72) Inventors: Anton WELLENHOFER, Hohenschäftlarn (DE); Jörg ZANDER, München (DE); Ekaterina ANANIEVA, München (DE); Florian HAIRER, München (DE); Michael BAUS, Gräfelfing (DE); Martin SCHUBERT, München (DE)

(21) Appl. No.: 17/051,130

(22) PCT Filed: Apr. 26, 2019
(86) PCT No.: PCT/EP2019/060800

§ 371 Date: Oct. 27, 2020

(30) Foreign Application Priority Data
Apr. 27, 2018 (DE) 10 2018 110 296.8
Jun. 19, 2018 (EP) 18178644.3

(51) Int. Cl. C02F 1/72

(52) U.S. Cl. CPC C02F 1/727; C02F 2101/101; C02F 2209/02

(57) ABSTRACT

The invention relates to a process for treating a sulfide-containing waste lye from a lye scrub in which the waste lye and oxygen or an oxygen-containing gas mixture is fed to an oxidation reactor (10) and in the latter is subjected to a wet oxidation, steam being fed into the oxidation reactor (10). It is provided that an oxidation reactor (10) with a number of chambers (11-19), of which a first chamber (11) has a greater volume than a second chamber (12), is used, the waste lye and the oxygen or the oxygen-containing gas mixture being fed to the first chamber (11), fluid flowing out of the first chamber (11) being transferred into the second chamber (12), the steam quantity and/or steam temperature of the steam fed into the oxidation reactor (10) being controlled by a control device (TIC), and the steam fed into the oxidation reactor (10) being at least partially fed into the first chamber (11) and into the second chamber (12). A corresponding installation (100) and also a corresponding oxidation reactor (10) are likewise the subject of the invention.

The invention relates to a process for treating a waste lye of a lye scrub using an oxidation reactor and to a corresponding installation and also a corresponding oxidation reactor according to the respective preambles of the independent patent claims.

### PRIOR ART

Olefins such as ethylene or propylene, but also diolefins such as butadiene and aromatics can be produced from paraffin by steam cracking. Corresponding processes have long been known. For details, also see the specialist literature such as the article “Ethylene” in Ullmann's Encyclopedia of Industrial Chemistry, online edition, 15 Apr. 2007, DOI 10.1002/14356007.a10_045.pub2.

Steam cracking produces so-called cracked gas, which along with the target products contains unconverted hydrocarbons and undesired byproducts. In known processes, this cracked gas is first subjected to a processing treatment before it is passed on to a fractionation to obtain various hydrocarbons or hydrocarbon fractions. Details are described in the cited article, in particular in section 5.3.2.1, “Front-End Section” and 5.3.2.2., “Hydrocarbon Fractionation Section”.

A corresponding processing treatment comprises in particular a so-called acid gas removal, in which components such as carbon dioxide, hydrogen sulfide and mercaptans are separated from the cracked gas. The cracked gas is typically compressed before and after a corresponding treatment. For example, the cracked gas may be removed from a so-called raw gas compressor at an intermediate pressure level, subjected to the acid gas removal, and subsequently compressed further in the raw gas compressor.

The acid gas removal may comprise in particular a so-called lye scrub using caustic soda solution. In particular when there are high concentrations of sulfur compounds, the lye scrub may also be combined with an amine scrub, for example by using ethanol amine. The waste lye obtained in the lye scrub, which contains several percent of sulfide and carbonate, is typically oxidized, and possibly neutralized, in a waste lye treatment before it can be subjected to a biological wastewater treatment. The oxidation serves for removing toxic components and for reducing the biological oxygen demand. The waste lye oxidation is typically carried out in the form of a chemical wet oxidation of the sulfide with oxygen in solution.

A number of different processes for wet oxidation of spent waste lyes are known from the prior art. For example, reference may be made to the article by C. B. Maugans and C. Alice, “Wet Air Oxidation: A Review of Commercial Sub-critical Hydrothermal Treatment”, IT3'02 Conference, 13 to 17 May 2002, New Orleans, La., or U.S. Pat. No. 5,082,571 A.

In such processes, the spent waste lye may be brought to the desired reaction pressure and heated up in countercurrent with the oxidized waste lye. The heated spent waste lye may subsequently be introduced into an oxidation reactor while supplying oxygen and be oxidized. The oxygen required for the reaction is in this case added either in the form of air or as pure oxygen. An additional heating of the spent waste lye, which in other variants of the process may also be the only heating, may be performed by introducing hot steam into the oxidation reactor.

After a typical residence time of about one hour (depending on the temperature chosen and the pressure chosen), the oxidized waste lye with the associated waste gas is cooled down by means of a heat exchanger while heating the spent waste lye. After checking the pressure, the waste gas is separated from the liquid in a subsequent separating vessel. After that, the liquid oxidized waste lye may be introduced into a process for biological wastewater treatment, while optionally setting the pH (neutralization).

Further processes and process variants are described in DE 10 2006 030 855 A1, U.S. Pat. No. 4,350,599 A and the article by C. E. Ellis, “Wet Air Oxidation of Refinery Spent Caustic”, Environmental Progress, volume 17, no. 1, 1998, pages 28-30.

The oxidation of the sulfur-containing compounds in the spent waste lye normally takes place in two different steps. During the oxidation of sulfides, sulfite, sulfate and thiosulfate are produced in parallel. While sulfite very quickly oxidizes further to form sulfate, the further reaction of thiosulfate is comparatively slow. The main reactions involved here are as follows:

2Na₂S+2O₂+H₂O⇄Na₂S₂O₃+2NaOH (1)

Na₂S₂O₃+2NaOH⇄2Na₂SO₄+H₂O (2)

Prior art for waste lye oxidation are an operating pressure of 6 to 40 bar and an operating temperature of up to above 200° C., for example up to 210° C. The higher the temperature in the reactor is chosen, the higher the pressure must be set, since the vapour pressure increases greatly with the temperature. The residence time in the reactor that is required for an extensive conversion falls from around the order of 12 hours at 6 bar to 10% of that residence time at 30 bar.

According to the prior art, the waste lye is fed into the oxidation reactor. An oxygen carrier, generally air, is mixed with the lye at any point desired, usually upstream of the actual reactor. The waste lye or the mixture of waste lye and oxygen carrier may be preheated in a heat exchanger.

According to the prior art, therefore, when it is fed into the oxidation reactor, the waste lye may be preheated. However, this is not absolutely necessary. Further heating (or the only heating) is often performed by means of adding steam, which may take place either into the incoming waste lye or directly into the reactor, and generally also by the reaction enthalpy or exothermicity of the oxidation reactions. As mentioned, in corresponding processes a preheating of the waste lye to the reactor may also be carried out as compared with the product from the reactor.

Since the pressure of the gas phase comprising the vapour pressure and the pressure of the oxidation air are added and the pressure of the inflowing steam must be at least as great as the reactor pressure, superheated steam especially comes into consideration for the adding of steam mentioned. This partially condenses, and in this way provides the additional heat.

According to the prior art, an oxidation reactor used for the waste lye oxidation is constructed in such a way that a directed flow forms in the reactor and, as a result, a greater reaction rate and a higher conversion are possible. For this purpose, internal fittings in the form of perforated trays may be used.

Processes of the aforementioned type are known for example from DE 10 2010 049 445 A1, in which a pressure of more than 60 bar is used in a corresponding reaction reactor, and from DE 10 2006 030 855 A1.

Because of the extreme loads, reactors for waste lye oxidation are produced from high-grade materials such as nickel-based alloys or nickel. However, even such materials can be attacked by high sulfate concentrations at elevated temperatures.

The mentioned adding of steam into the oxidation reactor is typically performed by means of one or more nozzles or lance constructions. The distribution of the steam should in this case take place as uniformly as possible over the surface area of the reactor, since the oxidation reactor, as mentioned, is typically flowed through in one direction and, as a result, the transverse mixing is limited. As explained below, in conventional processes and installations, a corresponding adding of steam cannot be controlled, or only to a slight extent.

According to GB 1 475 452 A, sludge is preheated using previously treated sludge and is supplied to an steam-supplied oxidizing chamber of a reactor partitioned into the oxidizing chamber and a heat concentrating chamber.

Disclosed in WO 2011/002138 A1 is a method of treating waste caustic soda, including neutralizing waste caustic soda produced by an oil refining process using sulfuric acid, and wet-air-oxidizing the neutralized waste caustic soda.

The present invention addresses the problem of providing a process for the wet oxidation of a waste lye that makes it possible to achieve an optimum oxidation of the sulfur constituents of the waste lye, in particular at operating pressure of 20 to 40 bar and with a minimal residence time. At the same time, the process is intended to be controllable over a wide operating range, in particular with the use of very different amounts of steam. In the process, the peak operating temperature is intended to be reduced in order to minimize the corrosion attack on the reactor material, which is especially dependent on the temperature. The present invention also addresses the problem of providing a correspondingly operable installation.

### Disclosure of the Invention

Against this background, the present invention proposes a process for treating a waste lye of a lye scrub by using an oxidation reactor and a corresponding installation with the features of the respective independent patent claims. Configurations are the subject of the dependent claims and of the description which follows.

### Advantages of the Invention

The present invention is based on the realization that the problems explained above can be overcome by the use in the way specified of an oxidation reactor configured as explained in detail below.

The present invention proposes here a process for treating a sulfide-containing waste lye from a lye scrub in which the waste lye and oxygen or the waste lye and an oxygen-containing gas mixture, for example air, are fed to an oxidation reactor and in the latter are subjected to a wet oxidation. Steam is fed into the oxidation reactor.

By the use of a corresponding process, the advantages explained above are achieved. When reference is made hereinafter to features and advantages of configurations of processes according to the invention, they apply in the same way to installations or oxidation reactors according to the invention with corresponding steam feeding devices. The features of processes and devices according to the invention and of corresponding variants are therefore explained together.

According to the invention, an oxidation reactor with a number of chambers, of which a first chamber has a greater volume than a second chamber, is used here. The waste lye and the oxygen or the waste lye and the oxygen-containing gas mixture are fed to the first chamber. Fluid flowing out of the first chamber is transferred into the second chamber. A steam quantity and/or a steam temperature of the steam fed into the oxidation reactor is controlled by a control device, and within the context of the present invention the steam fed into the oxidation reactor is at least partially, in particular completely, fed into the first chamber and into the second chamber.

In principle, the number of chambers used in the oxidation chamber used according to the invention is unlimited. However, typically at least four chambers are provided, including the mentioned first and second chambers. The chambers are preferably arranged in series one behind the other in a corresponding oxidation reactor. Typically, a corresponding oxidation reactor is in this case arranged upright, the said chambers lying one on top of the other. The oxidation reactor is typically flowed through by fluid from the bottom upwards, the mentioned first chamber representing the lowermost chamber and the mentioned second chamber representing the chamber following the lowermost chamber, arranged above the lowermost chamber.

The said chambers are typically delimited from one another by means of suitable separating devices, for example by sieve trays or by trays with nozzle valves for reducing the backflow, and consequently the backmixing. The feeding in of the steam is performed in the way explained below, i.e. in particular by using specifically formed steam feeding devices, which allow a wide variation of the quantities of steam that are fed in.

The invention comprises, as mentioned, that the steam fed into the oxidation reactor is at least partially fed into the first chamber and into the second chamber. In other words, the feeding of the steam therefore advantageously takes place in parallel into the first chamber and the second chamber. “Parallel” feeding in this case does not necessarily comprise the feeding of the same quantities of steam into the first chamber and into the second chamber, but of specific quantities of steam in each case.

In other words, the present invention comprises the use of a chamber near the inlet, the mentioned first chamber, and a second chamber, arranged downstream thereof in the direction of flow, in a corresponding reactor. The chamber near the inlet, that is to say the first chamber, and the chamber following thereafter, that is to say the second chamber, are provided with a steam lance or other feeding device for steam.

Within the context of the present invention, the chamber near the inlet (the first chamber) is increased in size in comparison with the chamber following it (the second chamber), and in particular in comparison with all of the other chambers of the oxidation reactor, whereby comparatively high conversions can be achieved in this chamber. The volume of the first chamber is particularly 1.1-fold, 1.5-fold, 2-fold, 3-fold or more than 3-fold of the volume of the second chamber. In this way, the occurrence of high reactant concentrations near the inlet can be prevented by the use of the oxidation reactor configured according to the invention. In other words, in the large first chamber near the inlet, a concentration of the sulfide that is introduced into the oxidation reactor by way of the waste lye is reduced. In other words, a rarefaction takes place in the first chamber. The lower sulfide concentration in this chamber in comparison with the high concentration in the waste lye fed in has the advantage that the corrosive attack on the reactor material is less. In particular in connection with the mentioned control of the steam quantity and the steam temperature of the steam fed into the oxidation reactor, this leads to a reduction of the corrosive attack on the reactor material.

Within the context of the present invention, saturated steam or steam superheated by at most 5 to 10° C. is advantageously fed to the oxidation reactor. The steam temperature of the steam fed into the oxidation reactor is in this case advantageously set by mixing in water in the heated steam. In other words, within the context of the present invention, a device that is fed superheated steam on the one hand and water on the other hand is advantageously used. This may involve using in particular a so-called deheater or desuperheater and a subsequent mixer. By metered feeding of the superheated steam to the desuperheater on the one hand and of the water to the desuperheater on the other hand, a mixing temperature that lies in the aforementioned range can be obtained. At the same time, by setting the quantity of the saturated steam or superheated steam and the water within the context of the invention, which is performed on the basis of setting by means of the mentioned control device, the quantity of steam obtained can be set.

Within the context of the present invention, the control is advantageously performed in such a way that the steam quantity and/or the steam temperature of the steam fed into the oxidation reactor is controlled on the basis of a temperature detected in the first chamber and/or the second chamber and on the basis of a detected temperature of a fluid flowing out of the reactor. In other words, within the context of the invention, the temperature control therefore advantageously comprises that a temperature measurement of the chambers of the oxidation reactor that are respectively provided with steam feeding devices is performed. On this basis, the quantity or quantities of fed steam is or are controlled. At the same time, an outlet temperature from the oxidation reactor is set or detected.

Advantageously, a control cascade is used here within the context of the present invention, comprising that the temperature of the lowermost chamber, that is to say the mentioned first chamber, is set to a setpoint value. At the same time, a maximum temperature that cannot or must not be exceeded in this first chamber is stipulated. Within the context of the control proposed according to the invention, the setpoint value used for the temperature in the first chamber is in this case stipulated on the basis of the outlet temperature, that is to say on the basis of the detected temperature of the fluid flowing out of the reactor. As a result, within the context of the present invention, the temperature at the top of the corresponding oxidation reactor can be compared with the temperatures in the said chambers. The measured temperature in the chambers in each case limits the quantity of steam that is fed into these chambers.

Use of the solution proposed according to the invention can make a wide operating range of ideally 0 to 100% load, in practice typically of 5 to 100% load, possible. The “load” corresponds here in particular to a quantity of steam. Use of the control used according to the invention means that it is no longer possible for operation to be limited by excessive process temperatures.

In other words, the control proposed according to the invention comprises stipulating a temperature setpoint value and a maximum temperature in the first chamber and/or the second chamber. On account of the stipulation to lower the temperature in the first chamber, that is to say the lowermost chamber, with the highest concentration of sulfide, the temperature in the second chamber would possibly be lowered to a lower value than is desired. Therefore, the mentioned feeding in of the steam is also performed into the second chamber. In this way, the latter can be specifically heated up, and the reaction conditions in this second chamber can be advantageously adjusted.

Therefore, as mentioned, the feeding of the steam is advantageously distributed between the two chambers or steam feeding devices provided there. The feeding of the steam to the two chambers is in this case advantageously controlled separately. Within the context of the control used according to the invention, the first chamber and the second chamber are therefore advantageously provided in each case with an independent temperature sensor and the control is respectively performed in control loops that are independent of one another. The quantity of steam that is fed into the lower chamber, that is to say the first chamber, is advantageously controlled to the temperature of the temperature element in the lowest, that is to say the first chamber. The control in the second chamber is cascaded, the temperature at the reactor outlet being taken into account. Advantageously, the respective setpoint value is therefore stipulated within the context of the present invention on the basis of the temperature of the fluid flowing out of the reactor.

Within the context of the present invention, the volume of the first chamber is advantageously greater than an average volume of all the chambers of the oxidation reactor, wherein particularly the factors indicated above apply. Alternatively or in addition, the size of the first chamber may also be defined with respect to the overall volume of the reactor. Advantageously, the volume of the first chamber is in this case at least one third and at most two thirds of an overall volume of all the chambers. In other words, as already mentioned, the chamber near the inlet is increased in size, whereas the other chambers are made smaller than the first chamber. The smaller chambers, which are in particular arranged downstream of the second chamber, have the task of reducing the residence time distribution, in order overall to optimize the conversion in the oxidation reactor.

As mentioned, within the context of the present invention, the steam quantity of the steam fed into the oxidation reactor can advantageously be controlled in a range of 5 to 100%. This means that a steam quantity of the steam fed in may correspond at a first point in time to 5% to 100% of the steam quantity fed in at a second point in time, or a corresponding setpoint value is stipulated by means of the control.

Within the context of the present invention, the steam is advantageously at least partially introduced into the oxidation reactor by means of a steam feeding device, which has one or more cylindrical sections with in each case a centre axis and in each case a wall, the centre axis being aligned perpendicularly, a number of groups of openings being formed in the wall, each of the groups comprising a number of the openings, and the number of openings of each of the groups being arranged in one or more planes that is or are in each case aligned perpendicularly to the centre axis. Within the context of the present invention, the first chamber and the second chamber may in particular each be provided respectively with a corresponding steam feeding device. A number of cylindrical sections may be provided, in particular in relatively large reactors. For the sake of clarity, reference is made hereinafter to “a” cylindrical section, but the explanations also relate to the case where a number of cylindrical sections are provided.

The construction of steam lances that are used in conventional processes makes minimizing the quantity of steam difficult to impossible. In the optimum case, the smallest quantity of steam fed in can be as a minimum 40%, in reality more likely as a minimum 60%, of the normal load, but not less. The reason for this is that, because there is an uneven flow across all of the lance holes, there is the likelihood of steam hammering occurring, due for example to local condensation and a poor distribution of the steam. On the other hand, the mentioned feeding in of the steam by means of the likewise mentioned steam feeding device makes particularly good controllability of the quantity of steam fed in possible.

By contrast with a horizontal pipeline provided in some known way with one or more rows of holes, within the context of the present invention steam is advantageously introduced into the reactor, and thereby into the waste lye or into a two-phase mixture of waste lye and air, exclusively by way of the mentioned cylindrical section of one or more corresponding steam feeding devices. The cylindrical section may in this case be formed as a “spigot”, which is arranged perpendicularly, in particular centrally, in a corresponding reactor. A corresponding oxidation reactor is for its part typically formed at least partially cylindrically. In these cases, in particular the centre axis of the cylindrical section of the steam feeding device and a centre axis of the oxidation reactor or its cylindrical section coincide.

The fact that the cylindrical section is arranged perpendicularly and is provided within it with a number of groups of openings that are arranged in a number of planes one above the other means that condensate can collect in the cylindrical section as a result of condensation of the steam and can form a level of condensate in a way corresponding to the pressure conditions in the cylindrical section. In other words, in the process according to the invention steam in the steam feeding device or in the cylindrical section thereof is made to condense, causing the formation in the cylindrical section of a level of condensate that depends in particular on the pressure of the steam fed in.

In the case of small volumes of steam, the cylindrical section fills with condensate to a comparatively great extent and the steam only flows through those openings that are formed in planes arranged further above. In this way it can be ensured that the openings flowed through in each case are optimally subjected to steam and that optimum flow conditions are established. By contrast, in conventional arrangements all of the openings are constantly subjected to steam, but the individual openings themselves are flowed through less well. Therefore, a process proposed according to the invention has the effect that there is a more even distribution of the steam and less of a tendency for steam hammering and surging to occur. When there is a higher load, i.e. when there are higher volumes of steam, and consequently a higher pressure in the cylindrical section, the cylindrical section is progressively drained further of condensate, and further openings that are arranged in lower-lying planes are flowed through by steam, until full load is achieved.

When it is mentioned within the context of the present application that each of the groups comprises a number of openings and the numbers of openings of each of the groups are arranged in one or more planes, this should be understood as meaning that different groups can in each case respectively have openings that can be arranged above and below a reference plane. In this way, even when a corresponding reactor is slightly tilted or there are turbulences of the level of condensate in the cylindrical section, in particular because of the feeding in of the steam, a sufficient through-flow can be ensured. In the simplest case, i.e. when the numbers of openings of each of the groups are respectively arranged in a plane, numbers of rows of holes are in this case arranged one above the other, the openings of different rows of holes advantageously being respectively staggered, in order that particularly good mixing of the steam can be ensured.

Advantageously, in each of the planes the respective openings here are arranged such that they are distributed equidistantly around the circumference defined by a sectional line of the respective plane with the wall. In other words, radial lines that extend from the centre axis in the corresponding plane and pass through the respective openings form identical angles. In this way, uniform mixing can be ensured, in particular in the case of a cylindrical formation of the oxidation reactor.

In the steam feeding device that is used in a corresponding process, the openings of each of the groups are advantageously arranged in numbers of planes and a maximum distance between the planes in which the openings of one of the groups lie is smaller than a minimum distance between the planes in which the openings of two different groups lie. As already mentioned, the opening of each of the groups therefore does not have to lie in precisely one plane, but may instead also be arranged in different planes, which however lie closer to one another than the planes of two different groups.

Advantageously, two, three, four or more of the openings are arranged in each of the planes and, as mentioned, are in this case distributed equidistantly along the wall around the circumference of the cylindrical section. This produces intermediate angles between the openings of 180°, 120° and 90°, respectively. The number of openings per plane may in this case also vary. In particular, the number of openings in the first plane may be minimized, so that the least possible underload operation can be ensured.

Advantageously, the cylindrical section of the steam feeding device has a first end and a second end and is closed at the first end by a terminating area. The first end in this case points downwards and ensures that the condensate can collect in the cylindrical section. In the terminating area there may in this case be formed in particular at least one further opening, which ensures that condensate can run out from the cylindrical section. It is also possible for a number of openings to be arranged in the terminating area, the size and number of which can in particular be based on the quantity of steam respectively to be processed or fed in.

Advantageously, the cylindrical section is connected by the second end to a steam supply line and/or mounting, which extends from the second end of the cylindrical section to a wall of the oxidation reactor used. If in this case a steam supply line is provided, it may in particular be cylindrically formed and have a diameter that is the same as or different from the cylindrical section of the steam feeding device. In order to ensure easier production, the diameters are advantageously identical.

Advantageously, the openings in the cylindrical section are arranged in such a way that steam respectively flows out from this section in an outflow direction that is different from a direction in which the steam supply line and/or the mounting extends when viewed from the direction of the centre axis. In other words, the opening or openings are respectively arranged in such a way that steam flowing out through it or them is advantageously not directed towards the supply line and/or mounting in order to ensure an outflow that is as free as possible.

In the process according to the invention, the waste lye and the oxygen or the oxygen-containing gas mixture are advantageously premixed before they are fed to the oxidation reactor. The waste lye and the oxygen or the oxygen-containing gas mixture are in this case advantageously fed to the oxidation reactor at ambient temperature and are only heated up in the latter. In this way, a temperature can be precisely set and controlled, in the first chamber in particular, in order to achieve the advantages explained above of reduced corrosive attack on the reactor.

The oxidation reactor as a whole is advantageously operated within the context of the present invention at a pressure level of 20 to 50 bar, in particular of 30 to 40 bar, and at a temperature level of 150 to 220° C., in particular of 185 to 210° C. By the configuration of the oxidation reactor that is provided according to the invention, corrosive attacks are in this case reduced.

The present invention also extends to an installation for treating a sulfide-containing waste lye from a lye scrub, for the features of which reference is expressly made to the respective independent patent claim. The same also applies correspondingly to the oxidation reactor proposed according to the invention. Advantageously, such an installation or a corresponding oxidation reactor is set up for carrying out a process as explained above in various configurations, and a corresponding installation has means correspondingly designed for this purpose. For corresponding features and advantages, reference is therefore made expressly to the above explanations.

The invention is explained in more detail below with reference to the appended drawings, which illustrate aspects of the present invention.

### BRIEF DESCRIPTION OF THE DRAWINGS

FIG. 1 shows in a simplified representation a process for treating a waste lye according to an embodiment of the invention.

FIG. 2 illustrates in a schematic partial representation an oxidation reactor for use in an installation according to an embodiment of the invention.

FIG. 3A illustrates a steam feeding device for use in an installation according to an embodiment of the invention in a first configuration.

FIG. 3B illustrates a steam feeding device for use in an installation according to an embodiment of the invention in a second configuration.

### DETAILED DESCRIPTION OF THE DRAWINGS

In the figures, elements that functionally or structurally correspond to one another are respectively indicated by identical designations. For the sake of clarity, these elements are not explained repeatedly.

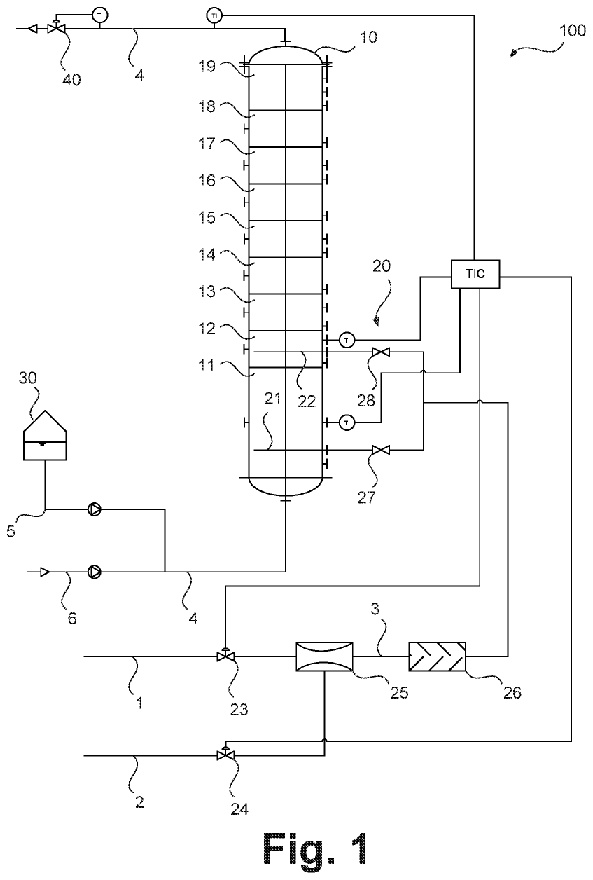

In FIG. 1, an installation for treating a waste lye according to a particularly preferred embodiment of the invention is schematically illustrated and is denoted overall by 100.

A central component of the installation 100 illustrated in FIG. 1 is an oxidation reactor 10. In the example represented, this oxidation reactor has altogether nine reactor chambers 11 to 19, at least however four reactor chambers.

A chamber 11 arranged lowest down in the example represented, near the inlet, and optionally the chamber 12 following thereafter are respectively provided with a steam feeder 21 and 22, for example a steam lance or a steam chamber protruding into the respective chamber 11, 12. The chamber 11 near the inlet is increased in size in comparison with the other chambers 12 to 19, with the aim of achieving relatively high conversions in this chamber, and in this way preventing the occurrence of high reactant concentrations near the inlet. The chamber 11 of increased size is larger than the average chamber volume and typically comprises more than one third of the overall reactor volume and typically less than two thirds thereof. The smaller chambers 12 to 19 above it have the task of reducing the residence time distribution in order to optimize the conversion.

The steam feeders 21, 22 are part of a steam system 20, which is based on a temperature indicator control TIC, to which a number of temperature indicators TI that are arranged at the chambers 11 and 12 and also at the outlet of the oxidation reactor 10 are connected. The temperature indicator control TIC controls two valves 23, 24, which are arranged upstream of a deheater or desuperheater 25, and by means of which an inflow of superheated steam 1 or boiler feed water 2 to the desuperheater 25 is set. Fluid 3 flowing out of the desuperheater 25 is mixed in a mixer 26 and subsequently distributed via valves 27 and 28 to the chambers 11, 12 or the steam feeders 21, 22.

The large chamber 21 near the inlet leads to a lower concentration of the sulfide. The lower sulfide concentration in this chamber 21 in comparison with the high inlet concentration has the advantage that the corrosive attack on the reactor material, together with an operating temperature controlled by means of the steam system 20, is less.

The temperature control by means of the steam system 20 takes place by the temperature measurement of the chambers 11, 12 respectively provided with steam feeders 21, 22 and controls the quantity (quantities) of fed steam. At the same time, an outlet temperature is set. For this reason, a control cascade is used. The temperature at the top of the oxidation reactor 10 is in this case compared with the temperatures in the chambers 11, 12 with the steam feeders 21, 22, and the measured temperature in the chambers 11, 12 with the steam feeders 21, 22 limits the fed quantity of steam. By means of the temperature indicator control, the temperature of the lowermost chamber 11 is set to a setpoint value, while a maximum temperature must not be exceeded. The setpoint value is in turn set by a second controller, which controls the outlet temperature at the top of the oxidation reactor 10.

The oxidation reactor 10 is fed a feed 4, which is typically two-phase and is formed by waste lye 5 removed from a tank 30 and air 6. In the example represented, the feed 4 is fed to the oxidation reactor 10 at ambient temperature and at 20 to 40 bar. A typically three-phase component mixture 4 is removed from the oxidation reactor 10. A flow of this component mixture from the oxidation reactor 10 is set by means of a valve 40, which is likewise operated in a temperature-controlled manner.

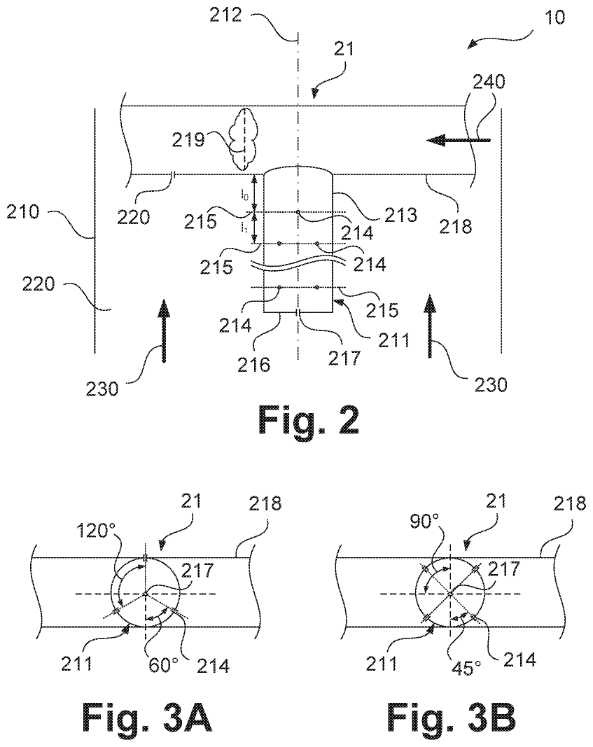

In FIG. 2, a section of an oxidation reactor for use in an installation according to a configuration of the present invention is schematically illustrated in a greatly simplified form and, as in FIG. 1, is denoted overall by 10. The oxidation reactor 10 has a wall 210, which encloses an interior space 220 of the oxidation reactor 10. A waste lye or a mixture of waste lye and air may be received in the interior space 220 and conducted for example substantially in the direction of the arrows respectively indicated by 230.

As mentioned, in particular the oxidation air and the waste lye may be heated up before being fed into the oxidation reactor 10. Additional heating may take place by means of a stream of steam 240, which is introduced into the oxidation reactor 100 or into the waste lye received in the latter, as illustrated here by means of a steam feeding device 21. The steam feeding device 22 that is represented in FIG. 1 may be formed identically.

The steam feeding device 10 in this case comprises a cylindrical section 211, which has a centre axis 212, which may in particular correspond overall to a centre axis of the oxidation reactor 10. The cylindrical section 211 comprises a wall 213. The centre axis 212 is aligned perpendicularly. Arranged in the wall 213 are a number of openings 214, which are only partially provided with designations. The openings 214 are arranged in numbers of groups, each of the groups comprising numbers of openings 214 and the numbers of openings of each of the groups being arranged in one or more planes, which have been illustrated here by dashed lines and are denoted by 215.

The planes 215 are in each case aligned perpendicularly to the centre axis 212. In other words, the centre axis 212 intersects the planes 215 perpendicularly. In this way, numbers of rows of openings 214 or rows of holes are formed within the context of the present invention, allowing condensate to build up in the cylindrical section 211, and steam only being introduced into the interior space 220 of the oxidation reactor 10, or into the waste lye present there, through the openings 14 that remain free. In this way, a corresponding oxidation reactor 10 can be operated in an optimized manner, as repeatedly explained above.

As explained, the openings 214 in the various planes 215 are provided in the same or different numbers, in a plane 215 represented here at the top in particular it only being possible for a relatively small number of openings to be provided, in order to make a minimum load possible. For the distances 10 and 11 of the individual planes 214 from one another and with respect to the cylindrical section 211, reference should be made expressly to the above explanations.

At a lower end or first end, the cylindrical section 211 is closed by a terminating area 216, in which at least one further opening 217 is arranged. At an opposite second end of the cylindrical section 211, the latter is connected to a steam supply line 218, which may have a diameter that is the same as or different from the cylindrical section. The row of openings 214 lying nearest the steam supply line 218 advantageously has in this case the smallest number of openings 214. The formation and alignment of the respective openings 214 have been explained in detail above. The steam supply line 218 is closed at one end by a closure, or it has one or more further openings 220.

In FIG. 3A, the steam feed device 21, which is already illustrated in FIG. 2 as part of the oxidation reactor 100, is represented in a different perspective, here a plan view along the axis 212 according to FIG. 2 being illustrated from below. As represented here, the openings 214 are in this case arranged in the cylindrical section 211 in such a way that an outflow direction for steam that is defined by them deviates from a centre axis of the steam supply line 218.

If in this case, as shown in the example represented in FIG. 3A, three openings are illustrated in a plane, an intermediate angle between them is 120°, and they are inclined at the angle represented of 60° with respect to a perpendicular to the centre axis of the supply line 218.

In FIG. 3B, the corresponding conditions already represented in FIG. 3A are represented for the case where four openings 214 are provided in a plane 215 of a corresponding cylindrical section 211.

1. A process for treating a sulfide-containing waste lye from a lye scrub in which the waste lye and oxygen or an oxygen-containing gas mixture is fed to an oxidation reactor (10) and in the latter is subjected to a wet oxidation, steam being fed into the oxidation reactor (10), characterized in that an oxidation reactor (10) with a number of chambers (11-19), of which a first chamber (11) has a greater volume than a second chamber (12), is used, the waste lye and the oxygen or the oxygen-containing gas mixture being fed to the first chamber (11), fluid flowing out of the first chamber (11) being transferred into the second chamber (12), the steam quantity and/or steam temperature of the steam fed into the oxidation reactor (10) being controlled by a control device (TIC), and the steam fed into the oxidation reactor (10) being at least partially fed into the first chamber (11) and into the second chamber (12).

2. The process according to claim 1, in which steam is fed into the oxidation reactor (10) as saturated steam or steam superheated by at most 5 to 10° C., the steam temperature of the steam fed into the oxidation reactor (10) being set by mixing in water in superheated steam.

3. The process according to claim 2, in which the quantity of the saturated steam and/or of the superheated steam and/or the water is set by means of the control device (TIC).

4. The process according to claim 1, in which the steam quantity and/or steam temperature of the steam fed into the oxidation reactor (10) is controlled on the basis of a temperature detected in the first chamber (11) and/or the second chamber (12) and on the basis of a detected temperature of a fluid flowing out of the reactor (10).

5. The process according to claim 4, in which the control comprises stipulating a temperature setpoint value and a maximum temperature in the first chamber (11) and/or the second chamber (12).

6. The process according to claim 5, in which the temperature setpoint value is stipulated on the basis of the temperature of the fluid flowing out of the reactor (10).

7. The process according to claim 1, in which volume of first chamber (11) is greater than an average volume of all the chambers (11-19) of the oxidation reactor (10) and/or comprises at least one third and at most two thirds of an overall volume of all the chambers (11-19).

8. The process according to claim 1, in which steam quantity of the steam fed into the oxidation reactor (10) is controlled in a range of 5 to 100%.

9. The process according to claim 1, in which the steam is at least partially introduced into the oxidation reactor (10) by means of a steam feeding device (21, 22), which has a cylindrical section (211) with a centre axis (212) and a wall (213), the centre axis (212) being aligned perpendicularly, a number of groups of openings (214) being formed in the wall, each of the groups comprising a number of the openings (214), and the number of openings (214) of each of the groups being arranged in one or more planes (215) that is or are in each case aligned perpendicularly to the centre axis (212).

10. The process according to claim 1, in which the waste lye and the oxygen or the oxygen-containing gas mixture are premixed before they are fed to the oxidation reactor (10), and in which the waste lye and the oxygen or the oxygen-containing gas mixture are fed to the oxidation reactor (10) at ambient temperature.

11. The process according to claim 1, in which the oxidation reactor (10) is operated at a pressure level of 20 to 50 bar and at a temperature level of 150 to 220° C.

12. Installation (100) for treating a sulfide-containing waste lye from a lye scrub, with means which are set up for feeding the waste lye and oxygen or an oxygen-containing gas mixture to an oxidation reactor (10) and in the latter subjecting it to a wet oxidation, means which are set up for feeding steam into the oxidation reactor (10) being provided, characterized in that the oxidation reactor (10) has a number of chambers (11-19), of which a first chamber (11) has a greater volume than a second chamber (12), means being provided for feeding the waste lye and the oxygen or the oxygen-containing gas mixture to the first chamber (11), transferring fluid flowing out of the first chamber (11) into the second chamber (12), controlling a steam quantity and/or steam temperature of the steam fed into the oxidation reactor (10) by a control device (TIC), and at least partially feeding the steam fed into the oxidation reactor (10) into the first chamber (11) and into the second chamber (12).

13. Oxidation reactor (10) for use in an installation (100) for treating a sulfide-containing waste lye from a lye scrub, the installation (100) having means which are set up for feeding the waste lye and oxygen or an oxygen-containing gas mixture to the oxidation reactor (10) and in the latter subjecting it to a wet oxidation, the oxygen reactor (10) having means which are set up for feeding steam into the oxidation reactor (10), characterized in that the oxidation reactor (10) has a number of chambers (11-19), of which a first chamber (11) has a greater volume than a second chamber (12), means being provided for feeding the waste lye and the oxygen or the oxygen-containing gas mixture to the first chamber (11), transferring fluid flowing out of the first chamber (11) into the second chamber (12), controlling a steam quantity and/or steam temperature of the steam fed into the oxidation reactor (10) by a control device (TIC), and at least partially feeding the steam fed into the oxidation reactor (10) into the first chamber (11) and into the second chamber (12).
